(19) United States
(12) Patent Application Publication
(10) Pub. No.: US 2023/0292675 A1
(43) Pub. Date: Sep. 21, 2023

(54) PLANTER FOR INDETERMINATE PLANT WITH SUPPORT

(71) Applicant: Reuban Edward James Nataraj, Germantown, MD (US)

(72) Inventor: Reuban Edward James Nataraj, Germantown, MD (US)

(21) Appl. No.: 17/700,099

(22) Filed: Mar. 21, 2022

(51) Int. Cl. A01G 9/12; A01G 9/02

(52) U.S. Cl. CPC A01G 9/126; A01G 9/124; A01G 9/02

(57) ABSTRACT

A planter for indeterminate plant with support comprising a planter with multiple clamp holders on helical shape and clamps, wherein the clamps are inserted into the clamp holders on the planter to form helical shape on which the plant stem is placed and filled with growing medium for new root formation from plant stem. The height of the plant is converted into the circumference of a helical shape on multiple stages as the plant grows. Using a telescopic pole, thread feeder and thread, an indeterminate plant is grown vertically.

### BACKGROUND OF THE INVENTION

### Field of the Invention

The present invention is in the field of gardening and more particularly to planter and support for indeterminate plant.

### Description of the Background Art

In gardening, an indeterminate plant is grown in a planter with limited height as it grows indeterminately. Typically, a vertical structure is placed near a plant in the early stages of growth; as the plant matures, it's difficult to grow due to the height constraint as it grows vertically without any limits.

One common type of load-supporting structure for indeterminate plants is conventional stakes, which are vertical members with limitations in height. The stakes extend downward such that they can be securely inserted into the soil surrounding the plant in the planter, and the plant cannot be grown beyond the height of the stakes.

There are several disadvantages associated with conventional stake (e.g., tomato stakes). For example, conventional plant load-supporting structures are relatively lengthy with limited height, and therefore, difficult to store and ship. Consequently, conventional plant load-supporting members are susceptible to tipping when the weight of the plant becomes too great or unbalanced. As another consequence of having to be staked into the soil, conventional load supporting structures cannot be used in situations wherein soft soil leads to unbalance the plant in the planter.

Therefore, what is clearly needed is a planter and support for an indeterminate plant that solves the problem mentioned above.

### SUMMARY OF THE INVENTION

The present invention overcomes the problems associated with indeterminate plant growth by converting the height of the plant into a circumference of helical shape and the plant stem is converted into new roots for the plant. The invention facilitates the support of growing indeterminate plants on a planter. The support structure is used in a planter which helps to grow the indeterminate plant vertically and is collapsible for easy, compact storage of space.

Planter for indeterminate plant with support includes planter base, telescopic pole, thread feeder, thread and planter with multiple clamp holders positioned in helical shape and clamps.

Using a planter with multiple clamp holders in a helical shape and clamps, the height of the indeterminate plant is converted into the circumference of a helical shape. A new growing medium is added above the indeterminate plant stem in which new roots are formed and as a result there will be high fruit yield.

The telescopic pole with thread feeder helps to grow the indeterminate plant in vertical position continuously without any limitation in height.

### BRIEF DESCRIPTION OF DRAWINGS

The objects, features and advantages of the present invention will be more readily appreciated as the same becomes better understood from the following detailed description when considered in connection with the accompanying drawing, wherein:

FIG. 1 is a top view of a planter base;

FIG. 2 is a front view of a planter base;

FIG. 3 is an isometric view of the planter base of FIG. 1;

FIG. 4 is a front view of a planter;

FIG. 5 is a top view of a planter;

FIG. 6 is an isometric view of the planter of FIG. 4

FIG. 7 is a front view of a clamp;

FIG. 8 is an isometric view of the clamp of FIG. 7

FIG. 9 is a front view of a telescopic pole;

FIG. 10 is a front view of a cantilever structure with thread feeder;

FIG. 11 is an isometric view of a cantilever structure with thread feeder of FIG. 10;

FIG. 12 is a front view pre-assembly of planter base, planter, telescopic pole, and cantilever structure with thread feeder;

FIG. 13 is a front view assembly of a planter base, planter, telescopic pole, and cantilever structure with thread feeder of the present invention;

FIG. 14 is a front view assembly of planter base, planter, telescopic pole, and cantilever structure with function of thread feeder;

FIG. 15 is a front view of a small indeterminate plant grown according to the present invention;

FIG. 16 is a front view of an indeterminate plant grown to the maximum height of the telescopic pole of the present invention;

FIG. 17 is a front view pre-assembly of clamps inserted into clamp holders on the planter of the present invention;

FIG. 18 is a front view assembly of clamps inserted into clamp holders on the planter of the present invention;

FIG. 19 is an isometric sectional view assembly of clamps inserted into the clamp holder on the planter of the present invention;

FIG. 20 is a front view of a plant stem placed above the clamps;

FIG. 21 is a front view of an indeterminate plant grown to the maximum height of the telescopic pole of the present invention;

FIG. 22 is a front view of additional clamps inserted into clamp holders on the planter of the present invention;

FIG. 23 is an isometric sectional view of additional clamps inserted into clamp holders on the planter of the present invention;

FIG. 24 is a front view of a plant stem placed above the additional clamps;

FIG. 25 is an isometric sectional view of a planter on which a plant stem is placed above multiple clamps;

### DETAILED DESCRIPTION OF THE INVENTION

The present invention overcomes the problems associated with the prior art, by providing a clamp that is inserted into a clamp holder slot on the planter. In the following description, numerous specific details are set forth (e.g., number of planter, clamp holders, clamps, telescopic pole, thread feeder, thread, etc.) in order to provide a thorough understanding of the invention.

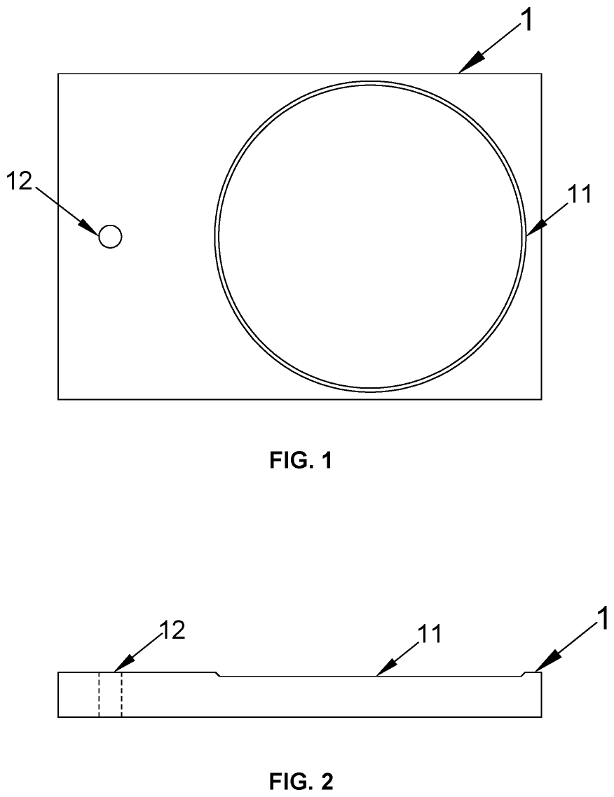

In FIG. 1 shows a front view of a planter base 1. The planter base 1 is in a rectangular shape which consists of a circular step section 11, such a way that the planter 2 fits in the circular step 11 and to ensure that the planter is not moved from its position. There is a hole 12 which is a tight fit hole to hold the telescopic pole vertically.

In FIG. 2 shows a front view of the planter base 1.

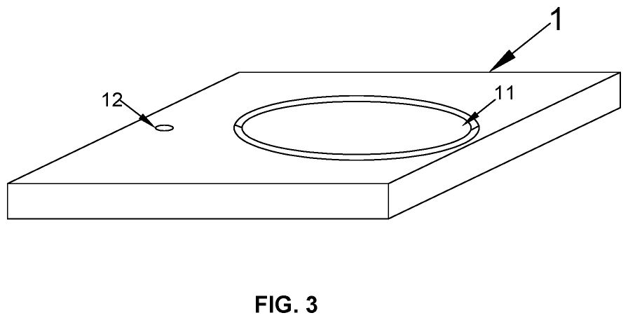

In FIG. 3 shows an isometric view of the planter base 1.

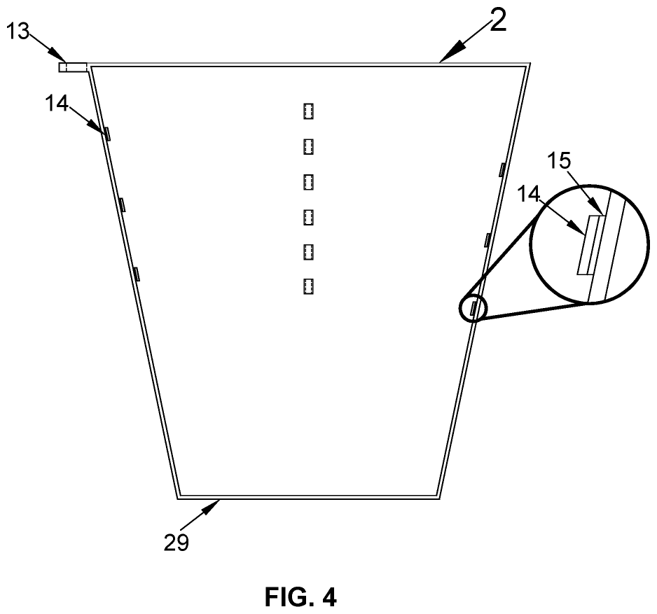

In FIG. 4 shows a front view of a planter 2. The planter 2 consists of hole 13 on the top edge of the planter, which gives more support to the telescopic pole 4. There are multiple clamp holders 14 on the planter 2 which are positioned in a helical shape. Minimum 3 or more clamp holders 14 to be considered for each 360 degrees. There is no limitation on no of clamp holder. In this example, 12 numbers of clamp holders are considered and each clamp holder is placed at 90 degrees. The clamp holder 14 consist of a slot section 15. The slot 15 can be in any space like rectangular, cylinder, etc. In this example, a rectangular slot is considered. The slot 15 should be hollow which ensures no growing medium is blocked in the slot 15 during assembly.

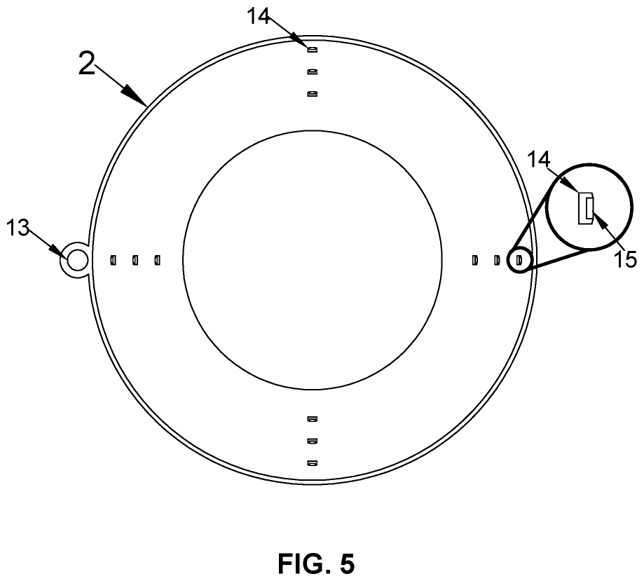

In FIG. 5 shows a top view of the planter 2.

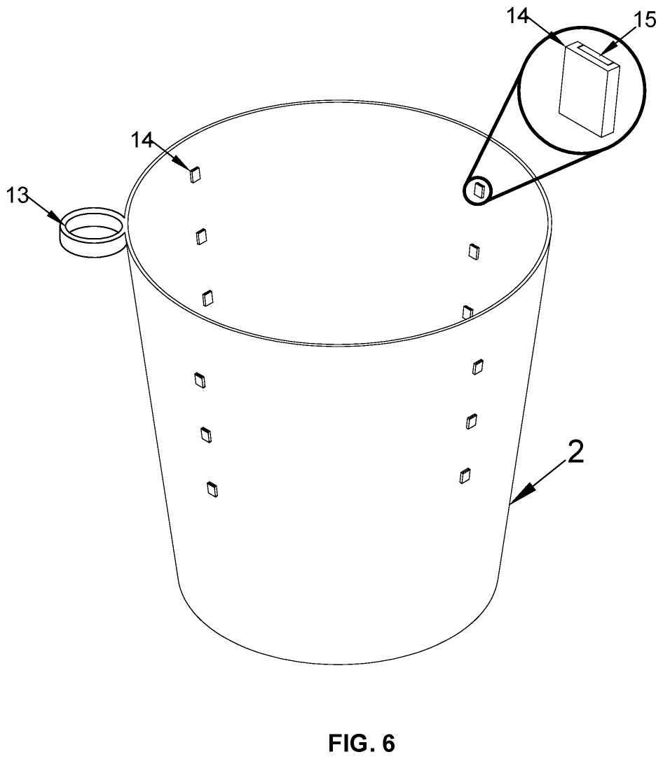

In FIG. 6 shows an isometric sectional view of the planter 2.

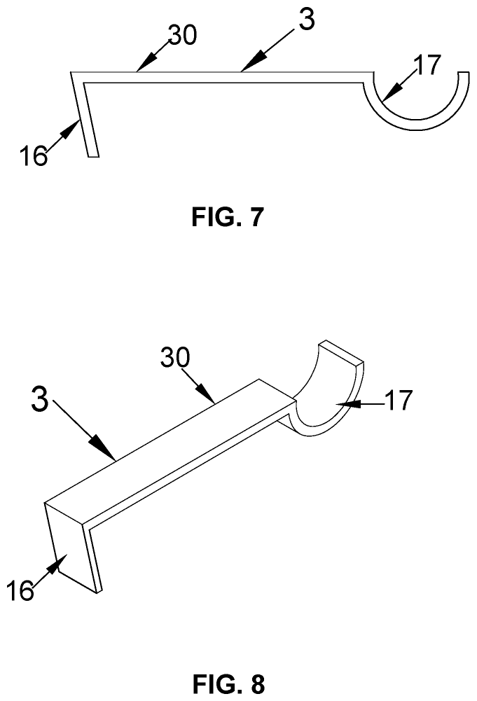

In FIG. 7 shows a front view of a clamp 3. The clamp 3 is a cantilever structure 30 with a semicircular profile 17 at the end.

In FIG. 8 shows an isometric view of the clamp 3.

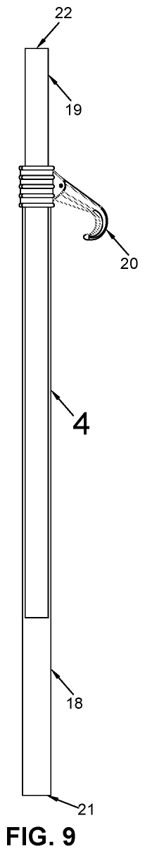

In FIG. 9 shows a front view of telescopic pole 4. Telescopic pole 4 consists of two poles which are circular tube profiles that have one fixed pole 18 and another adjustable pole 19. In fixed pole 18 one end is 21 and other end has a lock 20 which is used to lock the adjustable pole 19. One end of the adjustable pole 19 is inserted inside the fixed pole 18 and the other end 22 will be above the lock. The purpose of a telescopic pole is to control the vertical height of an indeterminate plant.

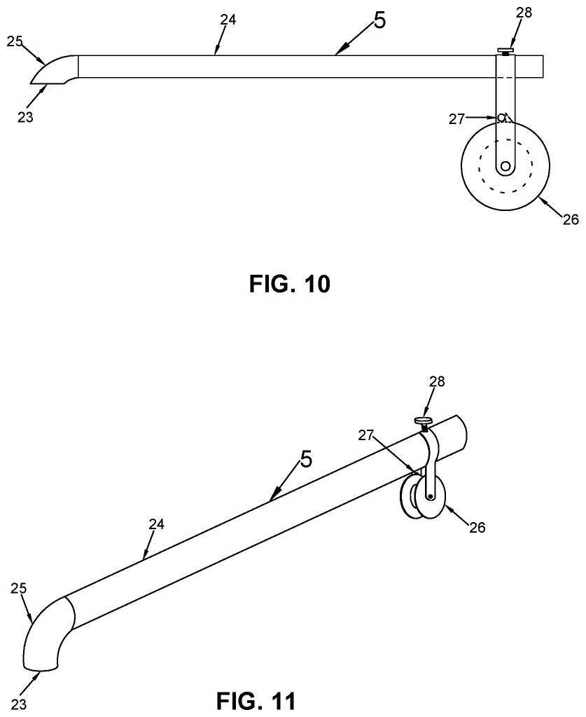

In FIG. 10 shows a front view of a cantilever structure with thread feeder 5, is an extended horizontal cantilever structure 24 to hold thread feeder 26. The thread feeder 26 can be slide along with the cantilever structure 24 and the thread feed 26 is locked with the screw 28. It also consists of an elbow 25 which is used to couple with a telescopic pole 4 through the hole 23, and the other side of elbow 25 is fixed with the horizontal structure. Horizontal structure can be any shape like square, cone, rectangle, circular, etc. In this example we have considered the circular shape.

In FIG. 11 shows an isometric view of the cantilever structure with thread feeder 5.

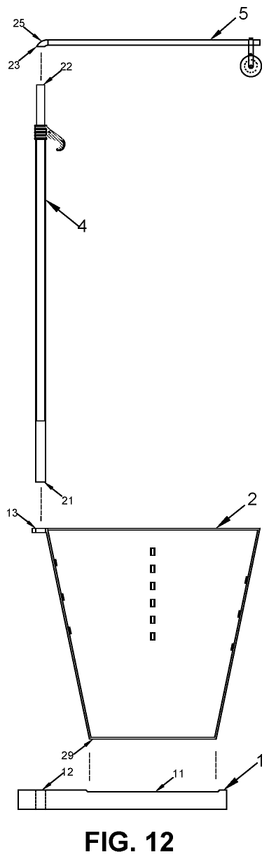

In FIG. 12 shows a front view pre-assembly of planter base 1, planter 2, telescopic pole 4 and cantilever structure with thread feeder 5. The bottom of the planter 29 is placed above the circular step 11 on the planter base 1. A growing medium is to be used in planter 2. Therefore, there is no need to fastening the Planter 2 with the planter base 1. The bottom end 21 of the telescopic pole 4 first is inserted through the hole 13 in the planter 2 and inserted inside the hole 12 of the planter base 1. This ensures that the telescopic pole 4 is in a vertical position. The top end 22 of the telescopic pole 4 is coupled with hole 23 of the cantilever structure with thread feeder 5.

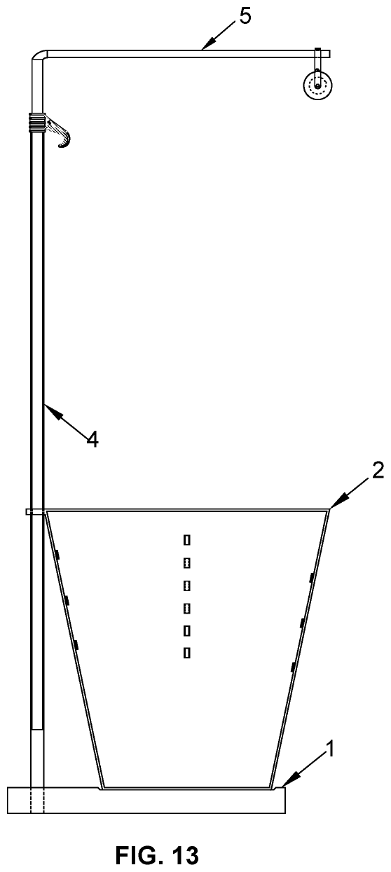

FIG. 13 shows a front view assembly of planter base 1, planter 2, telescopic pole 4 and cantilever structure with thread feeder 5.

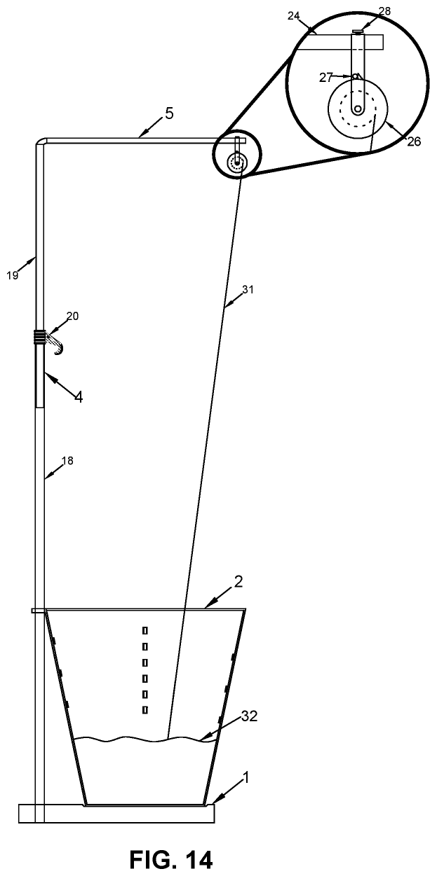

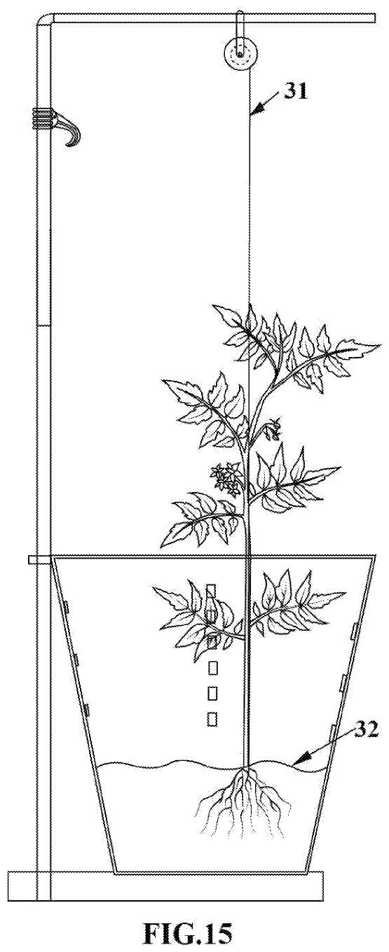

In FIG. 14 shows a front view assembly of planter base 1, planter 2, telescopic pole 4 and cantilever structure with thread feeder 5 function. Thread feeder 26 is used to feed thread 31 in which plant stem is grown along with the thread 31. Thread feeding is controlled by the stopper 27. Thread helps the indeterminate plant to hold vertically without any conventional supports. The height of the telescopic pole 4 is adjusted using the adjustable pole 19 and locked using the lock 20. The adjustable pole 19 can be rotated 360 degrees.

In FIG. 15 shows a front view of small indeterminate plant grown along the thread 31 on the present invention. In the planter the growing medium is filled up to level 32.

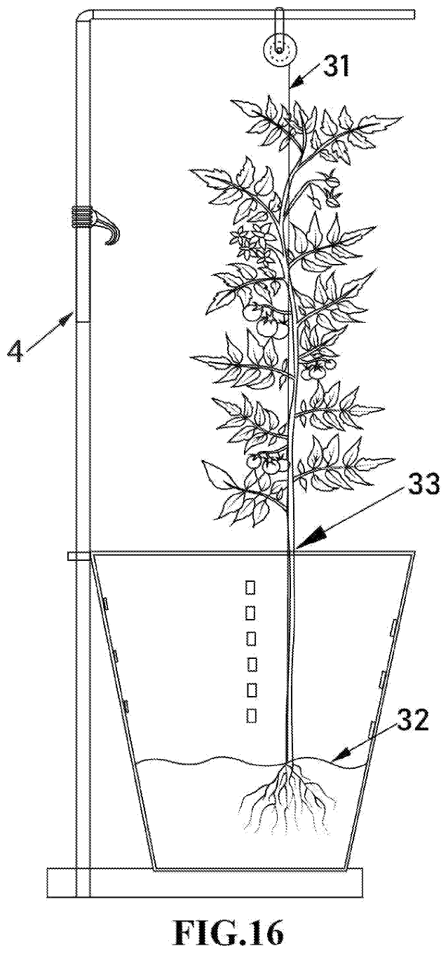

In FIG. 16 show a front view of an indeterminate plant grown to the maximum height of telescopic pole 4 on the present invention.

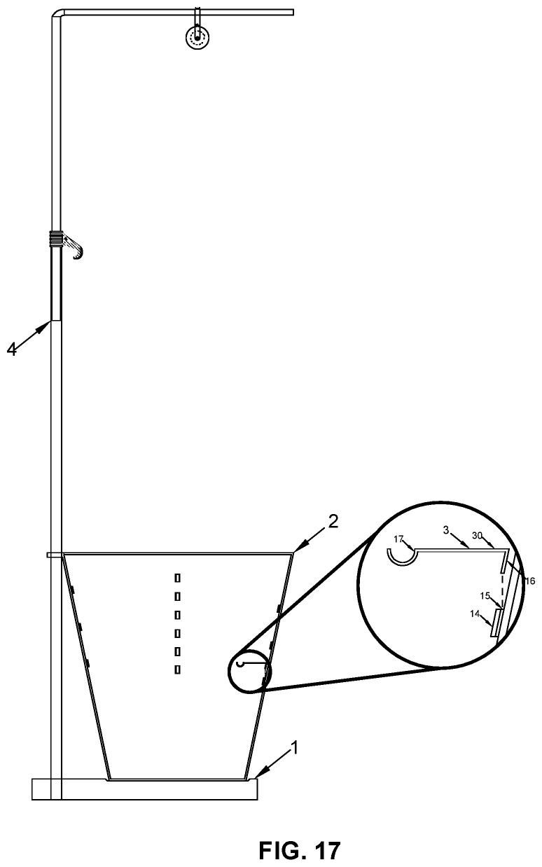

In FIG. 17 shows a front view pre-assembly of clamps 3 inserted with clamp holders 14 on planter 2. The surface 16 of the clamp 3 is inserted inside the slot 15 of the clamp holder 14. The no of clamps required will be based on the height of the plant that is to be converted into the circumference of the helical shape. For illusion purposes thread and plant have been removed.

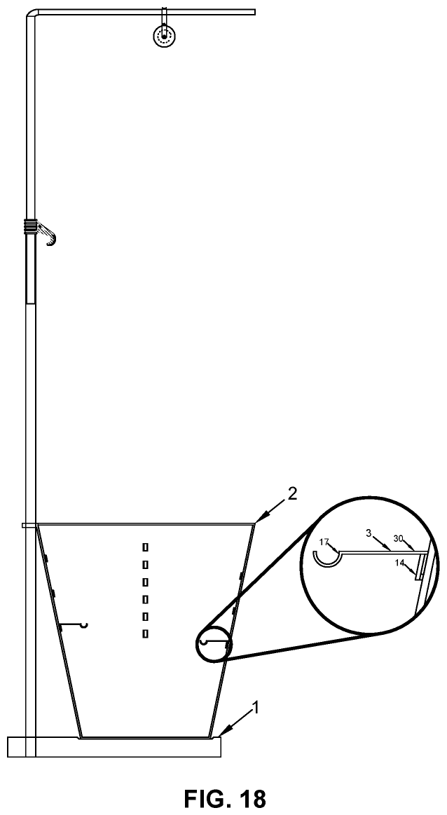

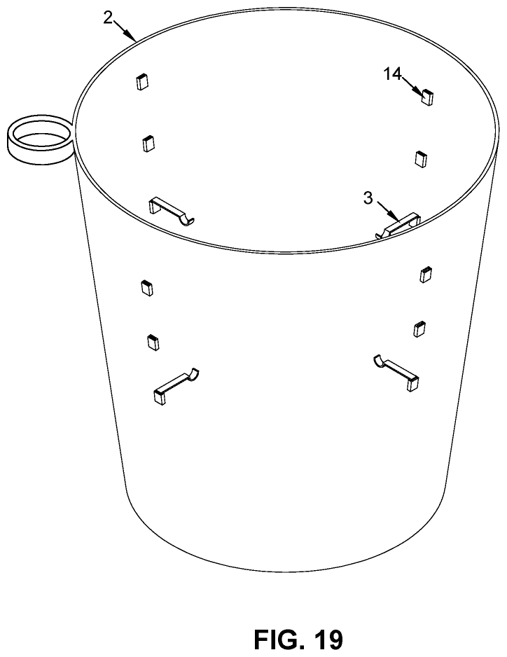

In FIG. 18 shows a front view assembly of clamps 3 inserted into clamp holders 14 on planter 2 of the present invention. For illusion purposes thread and plant have been removed.

In FIG. 19 shows an isometric sectional view assembly of clamps 3 inserted into clamp holders 14 on planter 2 of the present invention.

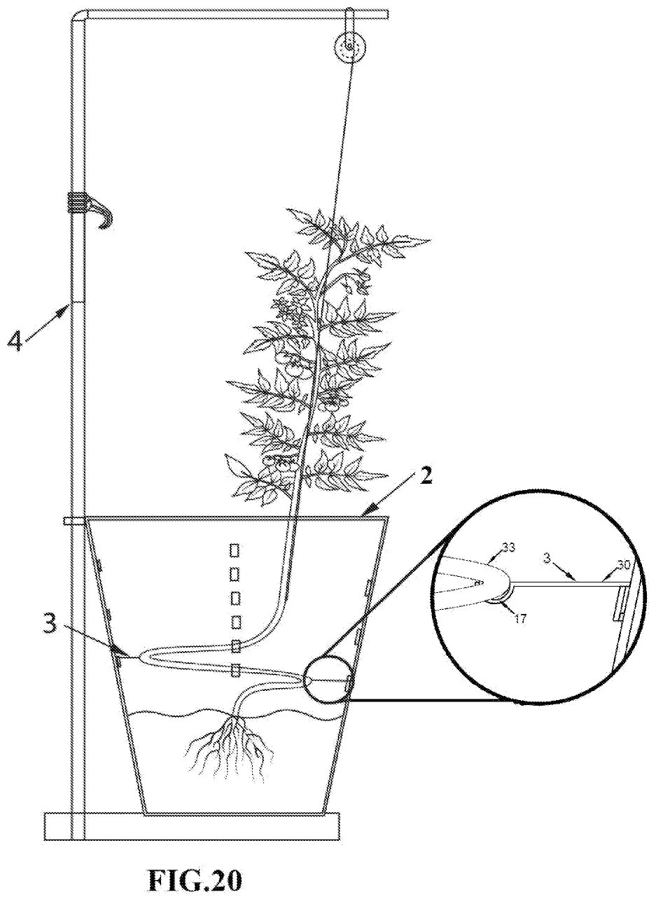

FIG. 20 shows a front view of a plant stem placed above the clamps. Once the plant reaches the max height of the telescopic pole 4. The plant stem 33 is placed on the semicircular profile 17 of the clamp 3. The cantilever structure 30 ensures the plant stem 33 is placed at a particular distance from the planter 2 wall in order to form new roots from the plant stem 33. The height of the plant is converted into the circumference of a helical shape and the plant height is reduced.

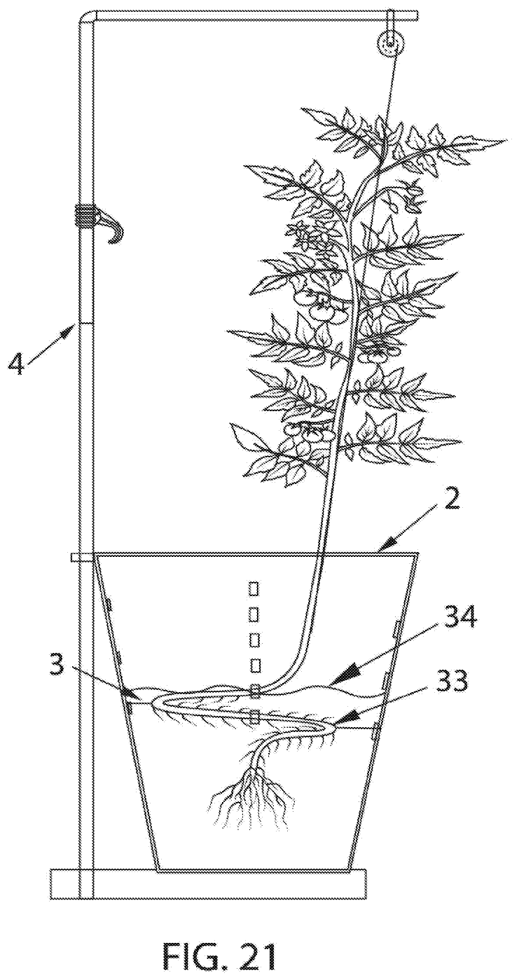

In FIG. 21 show a front view of an indeterminate plant grown to the maximum height of telescopic pole 4 on the present invention. Additional growing medium is added to planter 2 up to level 34. By adding growing medium, new roots are formed from the stem 33.

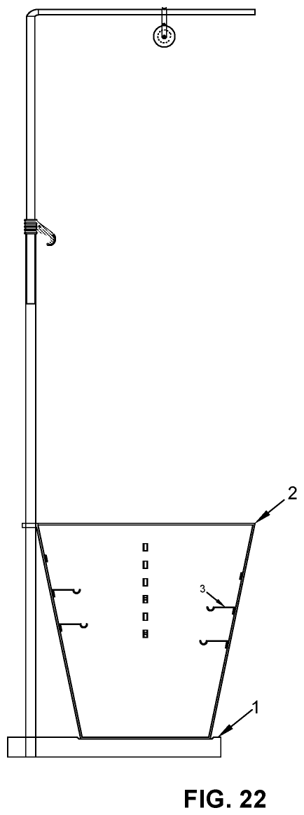

In FIG. 22 shows a front view assembly of additional clamps 3 inserted into clamp holders 14 on planter 2 of the present invention. For illusion purposes thread and plant have been removed.

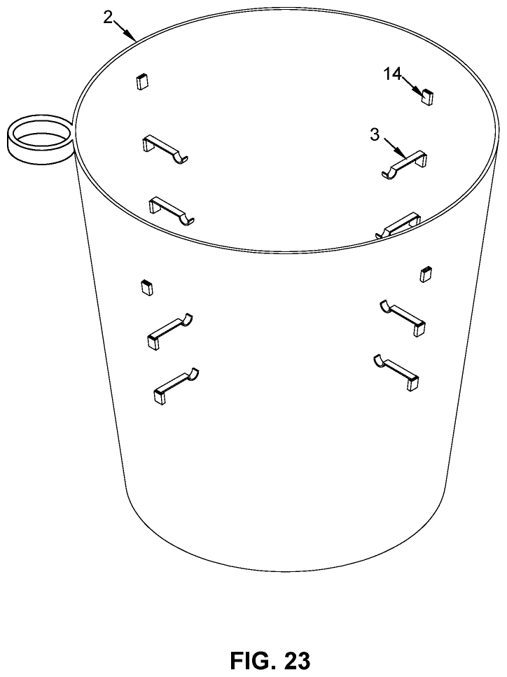

In FIG. 23 shows an isometric sectional view assembly of additional clamps 3 inserted into clamp holders 14 on planter 2 of the present invention.

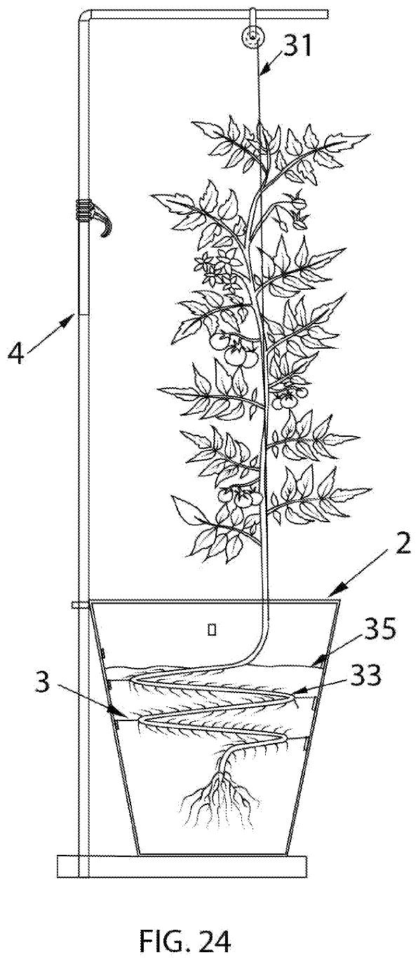

In FIG. 24 shows a front view of an indeterminate plant grown to the maximum height of telescopic pole 4 on the present invention. An additional growing medium is added to planter 2 up to the new level 35. By adding growing medium, new roots are formed from stem 33.

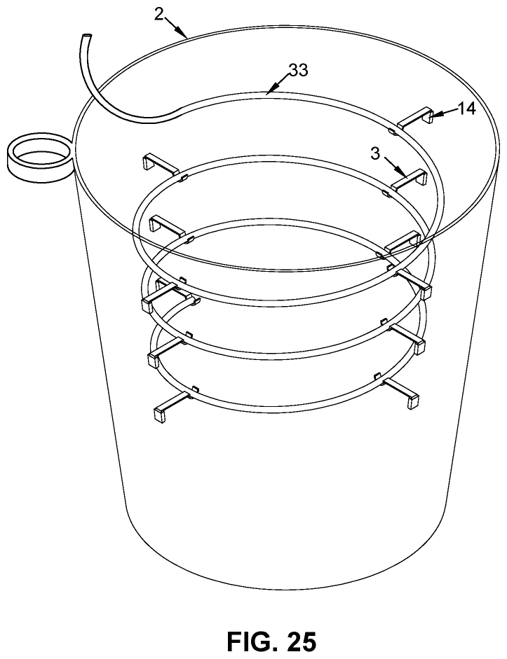

FIG. 25 shows an isometric sectional view of planter 2 on which plant stem 33 is placed above multiple clamps 3. As the plant grows and reaches the maximum height of the telescopic pole 4. The height of the plant is converted into a circumference of a helical shape and a new growing medium is added above the stem. By doing this, there will be new root formation, which leads to high yield. As the plant grows the process continues until the plant dies.

1. A planter for indeterminate plant with support comprising:
a planter with multiple clamp holders and clamp to form a helical shape;
a plant base, telescopic pole, cantilever structure for thread feeder and thread to grow the plant vertically;
The planter for indeterminate plant with support of claim 1 wherein said clamps are attached with clamp holders on the planter in a helical shape.
The planter for indeterminate plant with support of claim 1 wherein said indeterminate plant stem height is converted into a circumference of a helical shape by placing the stem on the clamps.
The planter for indeterminate plant with support of claim 1 wherein said helical shape is formed in multiple stages as the plant grows.
The planter for indeterminate plant with support of claim 1 wherein said new roots are formed in the indeterminate plant by adding growing medium on multiple stages which leads to high fruit yield.
The planter for indeterminate plant with support of claim 2 wherein said indeterminate plant is supported and grown vertically by using a planter base, telescopic pole, thread feeder and thread.
